(19) United States
(12) Patent Application Publication
(10) Pub. No.: US 2016/0152184 A1
(43) Pub. Date: Jun. 2, 2016

(54) HEAD-UP DISPLAY AND HEAD-UP DISPLAY PROGRAM PRODUCT

(71) Applicant: DENSO CORPORATION, Kariya city, Aichi-pref. (JP)

(72) Inventors: Hiroaki Ogawa, Kariya-city (JP); Makoto Sakai, Kariya-city (JP); Hiroshi Ando, Kariya-city (JP); Takayuki Fujikawa, Kariya-city (JP)

(21) Appl. No.: 14/899,515

(22) PCT Filed: Jun. 3, 2014
(86) PCT No.: PCT/JP2014/002928

§ 371 Date: Dec. 17, 2015

(30) Foreign Application Priority Data
Jun. 24, 2013 (JP) 2013-131800

(51) Int. Cl. B60R 1/00; G02B 27/01; G09G 5/10; G06T 19/00; G09G 5/373

(52) U.S. Cl. CPC B60R 1/00; G06T 19/006; G09G 5/373; G09G 5/10; G02B 27/0101; B60R 2300/205; G02B 2027/014; G02B 2027/0141

(57) ABSTRACT

A head-up display (10) equipped to a vehicle includes a front view information acquisition unit (22, S110, S120), a virtual image display unit (22, S180), and a size adjustment unit (22, S140-S160). The front view information acquisition unit acquires front view information indicative of an object existing on a travelling road of the vehicle. The virtual image display unit controls lights generated for displaying an object marker corresponding to the object indicated by the front view information acquired by the front view information acquisition unit to be reflected on a windshield (6) and displays the object marker as a virtual image in front of the vehicle. When the object is positioned ahead of the virtual image of the object marker in a traveling direction of the vehicle, the size adjustment unit adjusts a size of the object marker so that a length of the object marker in a width direction of the vehicle is at least equal to or longer than a display reference length, which is defined as a length of a line segment that connects, along the width direction of the vehicle and passing through the position where the virtual image of the object marker is formed, a straight line connecting a right eye of a driver of the vehicle with the object and another straight line connecting a left eye of the driver with the object.

### CROSS REFERENCE TO RELATED APPLICATION

This application is based on Japanese Patent Application No. 2013-131800 filed on Jun. 24, 2013, the disclosure of which is incorporated herein by reference.

### TECHNICAL FIELD

The present disclosure relates to a head-up display that displays information and a head-up display program product.

### BACKGROUND ART

A conventionally known head-up display (hereinafter referred to as “HUD”) projects light onto a windshield of a vehicle, forms a virtual image in the front field of view of a driver, and displays a marker (hereinafter referred to as “object marker”) indicative of a position where an object in the front field of view exists.

Under normal conditions, the position where the object exists is different from the position where an image of the object marker is produced. Therefore, when the driver focuses viewpoint on the object, the object marker is viewed as double vision images to the driver due to binocular parallax.

Regarding the above-described difficulty, it is proposed that a virtual image of the object marker be displayed on a straight line connecting the position where the object exists to a dominant eye of the driver (refer, for instance, to Patent Literature 1).

The HUD described in Patent Literature 1 assumes that the object marker is viewed only by the dominant eye of the driver. Under normal conditions, however, the shape of the virtually displayed object marker is not a single point, but is a region (surface) having a length in a width direction of the vehicle.

Consequently, it is difficult for the driver to view the virtual image of the object marker by using the dominant eye only. Thus, the driver views the virtually displayed object marker with both eyes including the non-dominant eye. When the driver views the object marker with both eyes as described above, the distance between the eyes of the driver and the position where an image of the object marker is formed is different from the distance between the eyes of the driver and the position where the really object exists. Therefore, in some cases, the driver views double vision images of the object marker due to binocular parallax.

In other words, when the driver focuses both eyes on the object positioned at a distance from the position where the virtual image is produced, conventional technologies may inadvertently cause the driver to recognize the virtual image as double vision images.

### PRIOR ART LITERATURE

### Patent Literature

[Patent Literature 1] JP 2009-269551 A

### SUMMARY OF INVENTION

In view of the foregoing difficulties, it is an object of the present disclosure to provide a head-up display and a head-up display program product each of which reduces a double vision effect of a virtual image of an object when both eyes of a driver are focused on the object existing at a position away from a position where the virtual image of the object is produced.

According to a first aspect of the present disclosure, a head-up display equipped to a vehicle includes a front view information acquisition unit, a virtual image display unit, and a size adjustment unit. The front view information acquisition unit acquires front view information indicative of an object existing on a road along which the vehicle travels. The virtual image display unit controls lights, which are generated for displaying an object marker corresponding to the object indicated by the front view information acquired by the front view information acquisition unit, to be reflected on a windshield of the vehicle and displays the object marker representing the object as a virtual image in front of the vehicle. The size adjustment unit adjusts a size of the object marker displayed by the virtual image display unit when a position where the object exists is ahead of a position where the virtual image of the object marker is formed in a traveling direction of the vehicle. The size adjustment unit adjusts the size of the object marker so that a length of the object marker in a width direction of the vehicle is at least equal to or longer than a display reference length. Herein, the display reference length is defined as a length of a line segment that connects, along the width direction of the vehicle and passing through the position where the virtual image of the object marker is formed, a straight line connecting a right eye of a driver of the vehicle with the object and another straight line connecting a left eye of the driver with the object.

When both eyes of the driver are focused on the object existing at a position away from a position where the virtual image is formed, the above-described head-up display is capable of restricting a case in which the virtual image of the object is viewed by the driver as double vision images.

A computer-readable head-up display program product includes instructions to be executed by a computer included in a head-up display equipped to a vehicle. The head-up display program product includes the instructions for implementing acquiring front view information indicative of an object existing on a road along which the vehicle travels, controlling lights, which are generated for displaying an object marker corresponding to the object indicated by the front view information acquired in an acquiring step of the front view information, to be reflected on a windshield of the vehicle and displaying the object marker representing the object as a virtual image in front of the vehicle, and adjusting a size of the object marker displayed in a displaying step of the object marker when a position where the object exists is ahead of a position where the virtual image of the object marker is formed in a traveling direction of the vehicle. The size of the object marker is adjusted so that a length of the object marker in a width direction of the vehicle is at least equal to or longer than a length of a line segment that connects, along the width direction of the vehicle and passing through the position where the virtual image of the object marker is formed, a straight line connecting a right eye of a driver of the vehicle with the object and another straight line connecting a left eye of the driver with the object.

When both eyes of the driver are focused on the object existing at a position away from a position where the virtual image is formed, the above-described head-up display program product is capable of restricting a case in which the virtual image of the object is viewed by the driver as double vision images.

### BRIEF DESCRIPTION OF DRAWINGS

The above and other objects, features, and advantages of the present disclosure will become more apparent from the following detailed description made with reference to the accompanying drawings. In the drawings:

FIG. 1 is a schematic diagram illustrating a configuration of a head-up display according to an embodiment of the present disclosure;

FIG. 2 is a schematic block diagram illustrating a configuration of the head-up display and a configuration of peripheral devices connected to the head-up display;

FIG. 3 is a flowchart illustrating processing steps of an information display process;

FIG. 4 is a diagram illustrating a display size of an object marker;

FIG. 5 is a diagram illustrating an exemplary brightness distribution of an object marker;

FIG. 6 is a diagram illustrating a display example of an object marker;

FIG. 7A is a diagram exemplifying an object marker viewed by a driver;

FIG. 7B is a diagram illustrating a brightness distribution of the object marker depicted in FIG. 7A;

FIG. 8A is a diagram illustrating an exemplary modification of a brightness distribution of the object marker;

FIG. 8B is a diagram illustrating an effect produced by the exemplary modification of the brightness distribution of the object marker;

FIG. 9A is a diagram illustrating an exemplary modification of a shape of the object marker;

FIG. 9B is a diagram illustrating an effect produced by the exemplary modification of the shape of the object marker;

FIGS. 10A, 10B, 10C, 10D, 10E, 10F, 10G, 10H, and 10I are diagrams illustrating exemplary modifications of a shape of the object marker; and

FIGS. 11A, 11B, 11C, 11D, 11E, 11F, 11G, 11H, and 11I are diagrams illustrating effects produced by the exemplary modifications of the shape of the object marker.

### EMBODIMENTS FOR CARRYING OUT INVENTION

An embodiment of the present disclosure will now be described with reference to the accompanying drawings.

(Head-up Display)

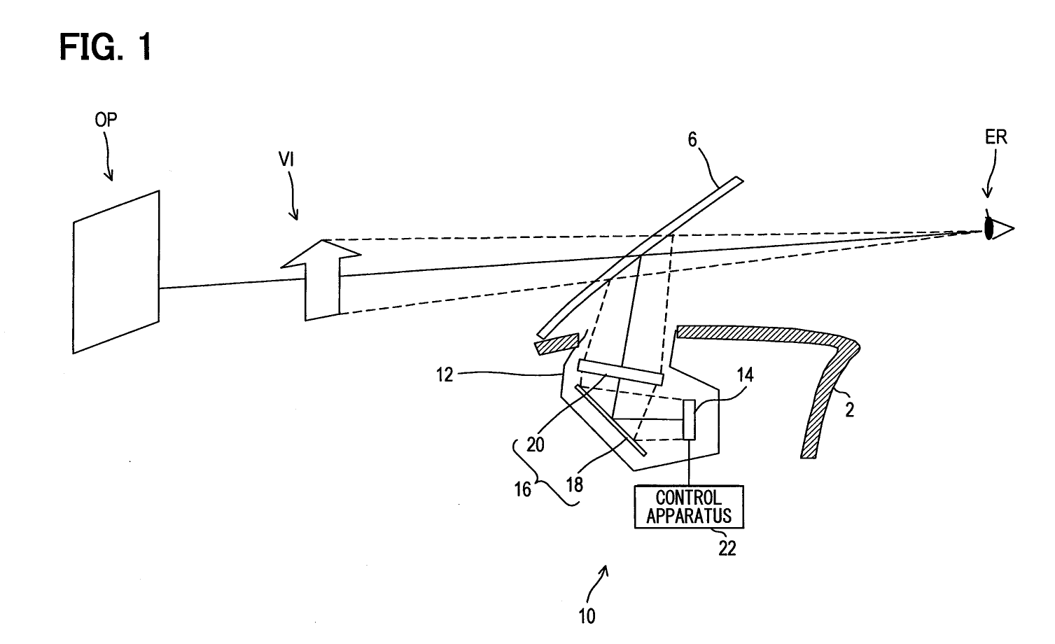

A head-up display 10 illustrated in FIG. 1 is equipped to a vehicle to display a virtual image VI of various information on a windshield 6. When a driver of a subject vehicle is viewing an object OP existing on a road along which the subject vehicle is traveling, the head-up display 10 provides the driver with various kinds of information by displaying the information on the windshield 6 as a virtual image VI without requiring the driver to shift the driver's line of sight.

The various information displayed as a virtual image VI includes vehicle information and front view information. The vehicle information is information indicative of a status of the subject vehicle. The vehicle information includes information related to the status of the subject vehicle such as a traveling speed and direction indication of the subject vehicle and various kinds of warnings.

The front view information indicates a status of a road along which the subject vehicle travels. The front view information includes information related to a road along which the subject vehicle is traveling (for example, information related to a speed limit and various road signs), information related to a scheduled travel route along which the subject vehicle is scheduled to travel, and information related to a follow-up target during adaptive cruise control.

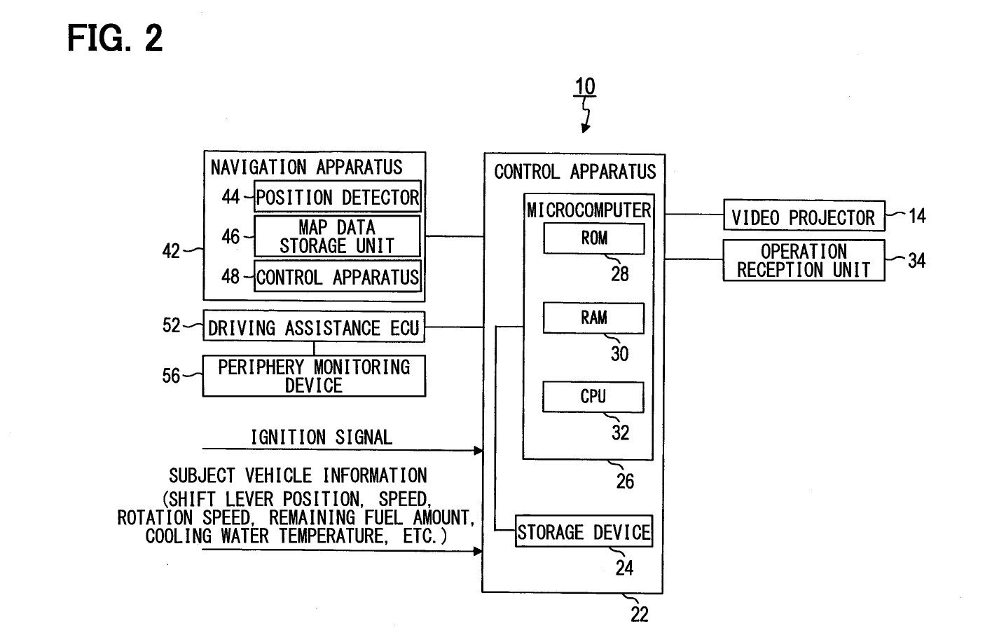

The head-up display 10 includes a case 12, an image projector 14, an optical member 16, a control apparatus 22, and an operation reception unit 34 (see FIG. 2).

The image projector 14 projects at least one of the vehicle information or the front view information. For example, a well-known liquid-crystal display may be used as the image projector 14.

The optical member 16 is configured so that an image (light) projected from the image projector 14 onto the windshield 6 has a specific size. The optical member 16 in the present embodiment includes a reflection mirror 18 and a lens 20. The reflection mirror 18 has at least one mirror and reflects the image (light) projected from the image projector 14. The lens 20 enlarges or shrinks the image (light) projected from the image projector 14.

The case 12 is a housing with an opening portion. The case 12 houses the image projector 14 and the optical member 16. The case 12 in which the image projector 14 and the optical member 16 are housed is disposed in a dashboard 2 of the vehicle. A light-transmissive cover may be installed over the opening portion of the case 12.

More specifically, the head-up display 10 is configured so that the light of image emitted from the image projector 14 and transmitted through the optical member 16 and the opening in the case 12 is projected onto the windshield 6. The image projected onto the windshield 6 is a virtual image VI that is formed in front of the subject vehicle within the driver's line of sight (namely, within an eye range ER). The head-up display 10 configured as described above enables the driver to view the object OP existing on a road along which the subject vehicle is traveling and the virtual image VI projected onto the windshield 6 without requiring the driver to shift the driver's line of sight.

The operation reception unit 34 depicted in FIG. 2 includes a switch and a button that receive various operations.

The control apparatus 22 includes a storage device 24 and a microcomputer 26. The storage device 24 is provided by a nonvolatile storage that is capable of rewriting storing information.

The microcomputer 26 is mainly provided by a well-known computer that includes at least a ROM 28, a RAM 30, and a CPU 32. The ROM 28 stores a processing program and data that need to be stored even after power off. The RAM 30 temporarily stores a processing program and data. The CPU 32 performs various processes according to a processing program stored in the ROM 28 or the RAM 30.

The ROM 28 stores a processing program that enables the microcomputer 26 to perform an information display process for the purpose of controlling the image projector 14 in such a manner that the vehicle information and front view information from various peripheral devices are projected onto the windshield 6. Herein, various peripheral devices are connected to the control apparatus 22.

As peripheral devices from which the control apparatus 22 acquires vehicle information and front view information, at least a navigation apparatus 42 and a driving assistance electronic control apparatus (hereinafter referred to as “driving assistance ECU”) 52 are connected to the control apparatus 22.

The navigation apparatus 42 includes a position detector 44, a map data storage unit 46, and a control apparatus 48. The position detector 44 detects the current position of the vehicle. The map data storage unit 46 stores map data. The navigation apparatus 42 is a well-known apparatus that provides guidance on a route to a preselected destination on the basis of a result that is obtained by collating the current position detected by the position detector 44 with the map data stored in the map data storage unit 46. The map data is well-known data including, for example, node data, link data, and cost data. The map data includes various information such as the speed limit of a road, the number of traffic lanes of a road, and the information related to an intersection.

The driving assistance ECU 52 is a well-known control apparatus that provides driving assistance control by controlling a drive system and braking system mounted in the subject vehicle. The driving assistance control includes cruise control, adaptive cruise control, and pre-crash safety control. Cruise control is exercised to maintain the speed of the subject vehicle within a permissible range of a preselected speed. Adaptive cruise control is exercised to maintain the distance between a preceding vehicle and the subject vehicle within a permissible range of a preselected distance. Pre-crash safety control is exercised to increase braking force and seat belt restraining force when an obstacle exists on a road on which the subject vehicle is traveling and within a predetermined distance from the subject vehicle.

At least a periphery monitoring device 56 is connected to the driving assistance ECU 52 in order to implement the driving assistance control. The periphery monitoring device 56 is a well-known device that monitors the status of the periphery of the subject vehicle. A camera that detects an object existing around the subject vehicle on the basis of a captured image showing the periphery of the subject vehicle, and an exploration device that detects an object existing around the subject vehicle on the basis of a result of exploration wave transmission and reception may be used as the periphery monitoring device 56. The exploration device may be, for example, well-known sonar that uses a sound wave as an exploration wave, a radar device that uses a radio wave as the exploration wave, or a radar device that uses laser light as the exploration wave.

Consequently, the driving assistance ECU 52 exercises pre-crash safety control on the basis of an obstacle detected by a monitoring operation performed by the periphery monitoring device 56, and exercises adaptive cruise control on the basis of a preceding vehicle (follow-up target) detected by a monitoring operation performed by the periphery monitoring device 56.

The control apparatus 22 may acquire the front view information from the navigation apparatus 42. In this case, the front view information includes information related to the speed limit of a road related to the current position where the subject vehicle is traveling, information related to the number of traffic lanes of the road, and information related to a scheduled travel route of the subject vehicle. Further, the control apparatus 22 may acquire the front view information from the driving assistance ECU 52. In this case, the front view information includes information related to the distance to a preceding vehicle and the orientation of the preceding vehicle (that is, the position where the preceding vehicle exists) and information related to a position where an obstacle exists.

The control apparatus 22 is provided with at least an ignition signal and subject vehicle status information.

The ignition signal is a well-known signal indicating that an ignition switch is turned on.

The subject vehicle status information is acquired as the vehicle information. The subject vehicle status information includes warning information indicating that, for example, the amount of remaining fuel for an internal combustion engine or the temperature of cooling water for the internal combustion engine is in a predetermined abnormal state. The abnormal state arises when, for example, the amount of remaining fuel is equal to or less than a prescribed threshold amount or the temperature of cooling water is equal to or higher than a prescribed threshold temperature.

The subject vehicle status information further includes the result of direction indicator operation, the traveling speed of the subject vehicle (that is, the vehicle speed), and the shift lever position of the subject vehicle.

(Information Display Process)

The information display process to be performed by the control apparatus 22 starts in response to an input of the ignition signal.

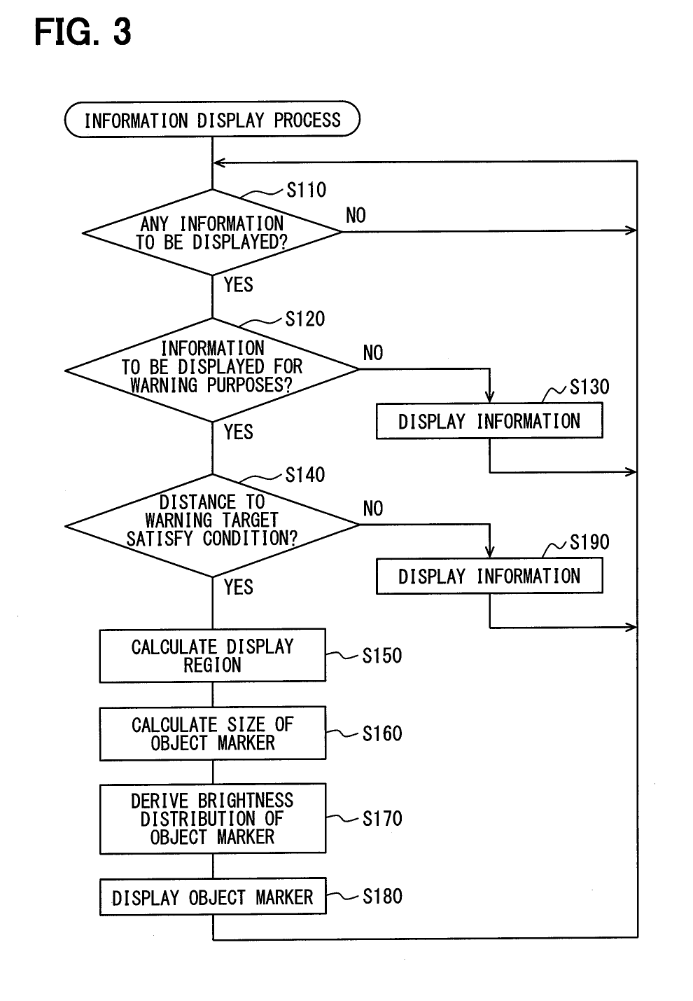

When the control apparatus 22 starts the information display process, the control apparatus 22 first determines whether information to be projected onto the windshield 6 (hereinafter referred to as “display purpose information”) exists, as indicated in FIG. 3 (S110). The display purpose information is information that needs to be displayed to the driver and is preliminarily determined. For example, the display purpose information may be provided by at least one item of the various kinds of vehicle information or may be provided at least one item of the various kinds of front view information.

When the result of determination in S110 indicates that no display purpose information exists (S110: NO), the control apparatus 22 waits until an acquirement of the display purpose information. When the display purpose information exists (S110: YES), the control apparatus 22 proceeds to S120.

In S120, the control apparatus 22 determines whether the display purpose information acquired in S110 is warning display purpose information. The “warning display purpose information” indicates the information to be displayed for warning purpose, and in the present embodiment, the warning display purpose information may include information indicating a position where a preceding vehicle exists and or information indicating a position where an obstacle exists among the front view information.

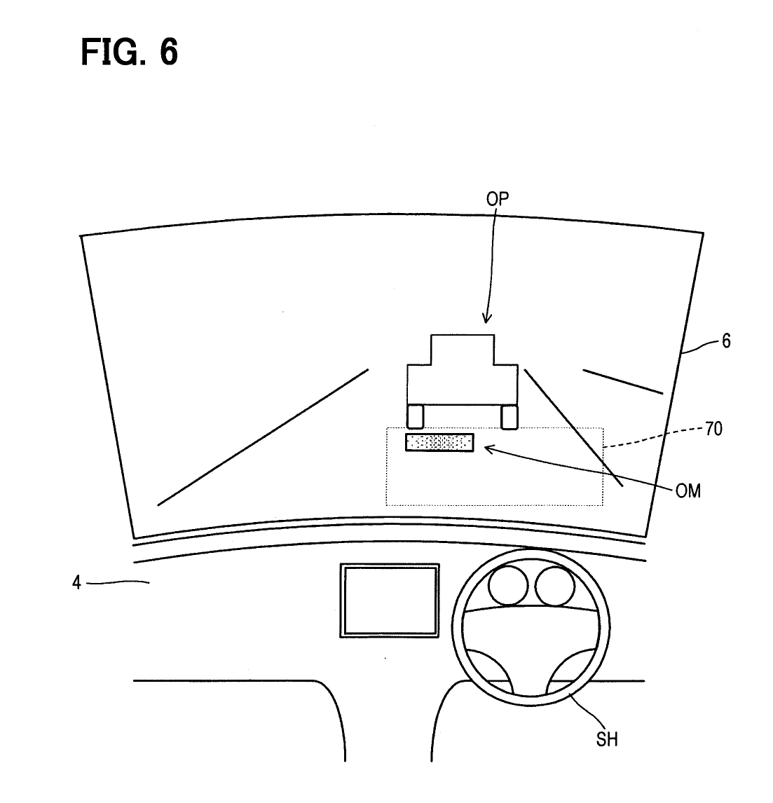

When the result of determination in S120 indicates that the display purpose information is not the warning display purpose informations (S120: NO), the control apparatus 22 controls the image projector 14 to project image corresponding to the display purpose information so that the display purpose information is displayed in a predetermined region of the windshield 6 (S130). In other words, when the display purpose information is the vehicle information, the vehicle information is projected onto a predetermined display region 70 (see FIG. 6) of the windshield 6 in S130. When the display purpose information is the front view information and is related to the speed limit of a road including the current position where the subject vehicle is traveling or related to the number of traffic lanes of the travelling road, or when the display purpose information is the front view information and is related to a scheduled travel route of the subject vehicle that is set in the navigation apparatus 42, the front view information is also projected onto the display region 70 of the windshield 6 in S130.

Subsequently, the control apparatus 22 proceeds to S110.

When the result of determination in S120 indicates that the display purpose information is the warning display purpose information (S120: YES), the control apparatus 22 determines whether a distance to an object OP that is to be displayed for warning display purpose (S140) satisfies a predetermined condition. The predetermined condition may be set as the distance from the driver to the object OP to be displayed for warning purpose along the traveling direction of the subject vehicle should be longer than a distance from the driver to a position at which the virtual image VI of the object is produced in front of the subject vehicle. In other words, in S140, the control apparatus 22 determines that predetermined condition is satisfied when the distance to a position where a target, such as a preceding vehicle or an obstacle exists as an object OP is longer than the distance to the predetermined position in front of the subject vehicle at which the virtual image VI is produced.

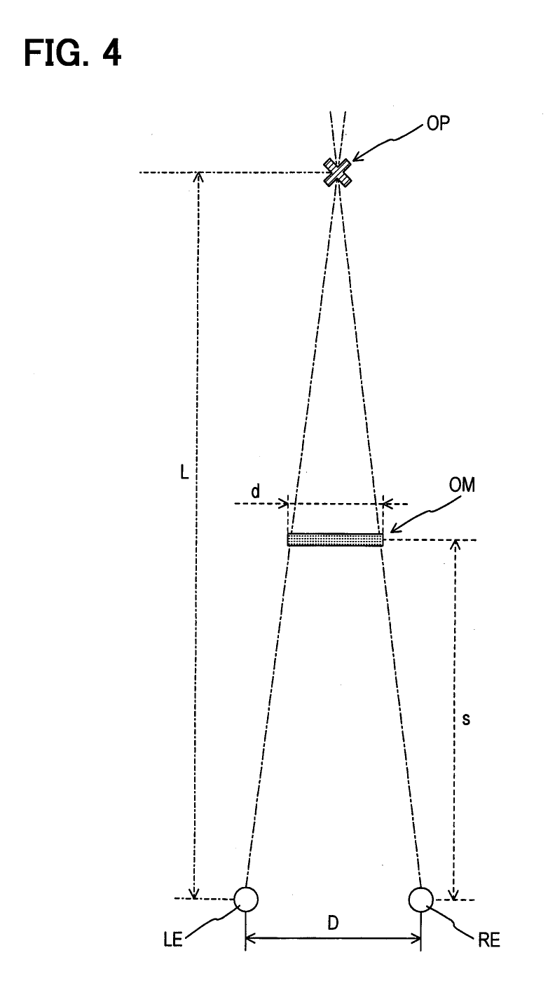

When the result of determination in S140 indicates that the distance to the object OP to be displayed for warning purpose satisfies the predetermined condition (S140: YES), the control apparatus 22 calculates a display region on the image projector 14 in which an object marker OM (see FIG. 4) is to be displayed as the warning display purpose information (S150). Here, the object marker OM causes the driver to notice an existence of the object OP. The object marker OM in the present embodiment has a rectangular (elongated) shape, and is longer in the width direction of the vehicle than in the height direction of the vehicle.

The calculation of the display region carried out in S150 may adopt a well-known method described below. When a preceding vehicle or an obstacle exists as an object OP and the position where the preceding vehicle or the obstacle exists is viewed through the windshield 6 by the driver's line of sight (for example, the eye range), the object OP is positioned at the lower portion of the windshield 6. Thus, the control apparatus 22 may calculate the above-described lower portion of the windshield 6 at first. Next, the control apparatus 22 may calculate, as the display region, a region of the image projector 14 which corresponds to the calculated lower portion of the windshield 6.

Next, the control apparatus 22 calculates a size of the object marker OM to be displayed on the image projector 14 (S160). More specifically, in S160, the control apparatus 22 calculates a length d of the object marker OM along the width direction of the vehicle so that the calculated length d satisfies the following expression (1), and calculates the size of the object marker OM to be displayed on the image projector 14 corresponding to the calculated length d.

$$[ Expression 1 ] \\ d \geq \frac{L - s}{L} \times D \qquad ( 1 )$$

As indicated in FIG. 4, the symbol L in expression (1) represents the distance between the eyes of the driver and an on-road position where a preceding vehicle or an obstacle exists as an object OR The distance L may be obtained from the result of detection by the periphery monitoring device 58.

The symbol s in expression (1) represents the distance between the eyes of the driver and the predetermined position in front of the subject vehicle at which the virtual image VI is formed (the object marker OM is imaged). This distance s is a predetermined value.

The symbol D in expression (1) represents the distance between a center of one eye and a center of the other eye of the driver, that is, the interval between the eyes of the driver. The “distance between the centers of the eyes of the driver” D may be an average value that is experimentally obtained by determining the distance between the centers of the right eye RE and left eye LE of certain amount of persons. Alternatively, the distance between the center of the right eye RE and the center of the left eye LE of the driver may be inputted through the operation reception unit 34 as the “distance between the centers of the eyes of the driver.”

In other words, the length d of the object marker OM in the width direction of the vehicle at a position where the virtual image VI of the object marker OM is formed is set to be at least equal to or longer than a length of a linear segment that is defined by intersections of a line passing through the length d of the object marker OM along the width direction of the vehicle with two straight lines that respectively connect the right and left eyes RE, LE of the driver to the object OP. More specifically, the length d of the object marker OM is set to be equal to or longer than the length of the above line segment which passes through the position where the virtual image VI of the object marker OM is formed in the width direction of the vehicle (the length of the object marker OM is referred to as “display reference length” hereinafter). That is, the display reference length is the distance between two intersection points at which a virtual straight line connecting the left eye LE of the driver to the object OP and a virtual straight line connecting the right eye RE of the driver to the object OP intersect with a virtual straight line that passes through a position where the object maker OM is formed in the width direction of the vehicle. The length d of the object marker OM along the width direction of the vehicle at the position where the virtual image VI is formed may be equal to or longer than the interval D between the eyes of the driver.

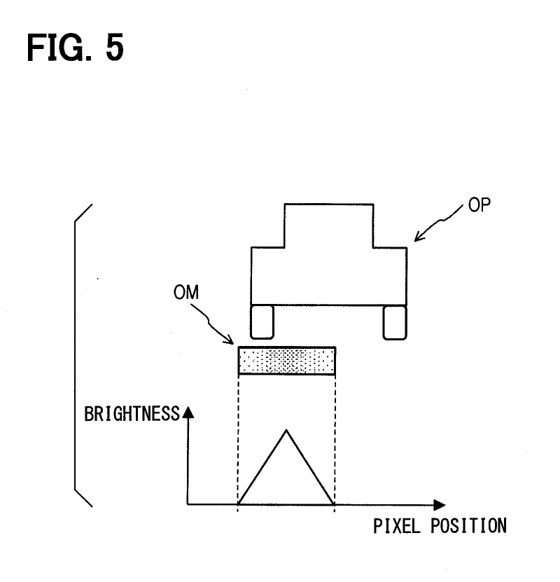

Further, the control apparatus 22 derives a brightness distribution of the object marker OM to be displayed on the image projector 14 (S170). In the present embodiment, S170 is performed to derive the brightness distribution of the object marker OM in such a manner that the brightness distribution in the width direction of the vehicle is relatively high at a central portion in the width direction of the vehicle and relatively low at both end portions in the width direction of the vehicle. More specifically, as indicated in FIG. 5, the brightness distribution of the object marker OM is adjusted in S170 so that the brightness is highest at the central portion in the width direction of the vehicle and decreases in proportion to the distance from the central portion in the width direction of the vehicle to a position toward an end portion in the width direction of the vehicle.

Next, the object marker OM having the size determined in S160 and the brightness distribution determined in S170 is projected from the region of the image projector 14 that is determined in S150 (S180). In other words, in S180, the object marker OM is projected onto the windshield 6 to form the virtual image VI of the object marker OM as indicated in FIG. 6.

Subsequently, the control apparatus 22 returns to S110.

When the result of determination in S140 indicates that the distance to the object OP to be displayed for warning purpose does not satisfy the predetermined condition (S140: NO), the control apparatus 22 controls the image projector 14 to project the image corresponding to the warning display purpose information (S180). In other words, in S180, the warning display purpose information is projected onto a predetermined display region 70 of the windshield 6.

Subsequently, the control apparatus 22 returns to S110.

In short, when the display purpose information exists, the control apparatus 22 in the present embodiment controls the image projector 14 to project each item of the display purpose information. This ensures that each item of acquired display purpose information is projected onto the display region 70 of the windshield 6 to form the virtual image of the information.

Further, when the display purpose information is to be displayed for warning purpose and the distance to the object OP that is to be displayed for warning purpose satisfies the predetermined condition, the control apparatus 22 controls the image projector 14 to project the object marker OM onto the windshield 6. This ensures that the virtual image VI of the object marker OM is formed.

In the above case, the size of the object marker OM in the width direction of the vehicle, which is to be projected by the image projector 14, is adjusted in such a manner that the length d of the object marker OM in the width direction of the vehicle at the position where the virtual image VI of the object marker OM is formed is at least equal to or longer than the length of the line segment that connects, along the width direction of the vehicle, two straight lines that respectively connect the right and left eyes RE, LE of the driver to the object OP, and equal to or longer than the length of the object marker OM in the width direction of the vehicle at the position where the virtual image VI is formed. Further, the brightness distribution of the object marker OM is adjusted in such a manner that the brightness distribution is relatively high at the central portion in the width direction of the vehicle and relatively low at both end portions in the width direction of the vehicle.

### Effects of the Embodiment

As described above, the head-up display 10 is configured so that the length of the object marker OM in the width direction of the vehicle at the position where the virtual image VI of the object marker OM is formed is at least equal to or longer than the length of the line segment that connects, along the width direction of the vehicle and passing through the position where the virtual image VI of the object marker OM is formed, a straight line connecting the right eye RE of the driver with the object OP and another straight line connecting the left eye LE of the driver with the object OP.

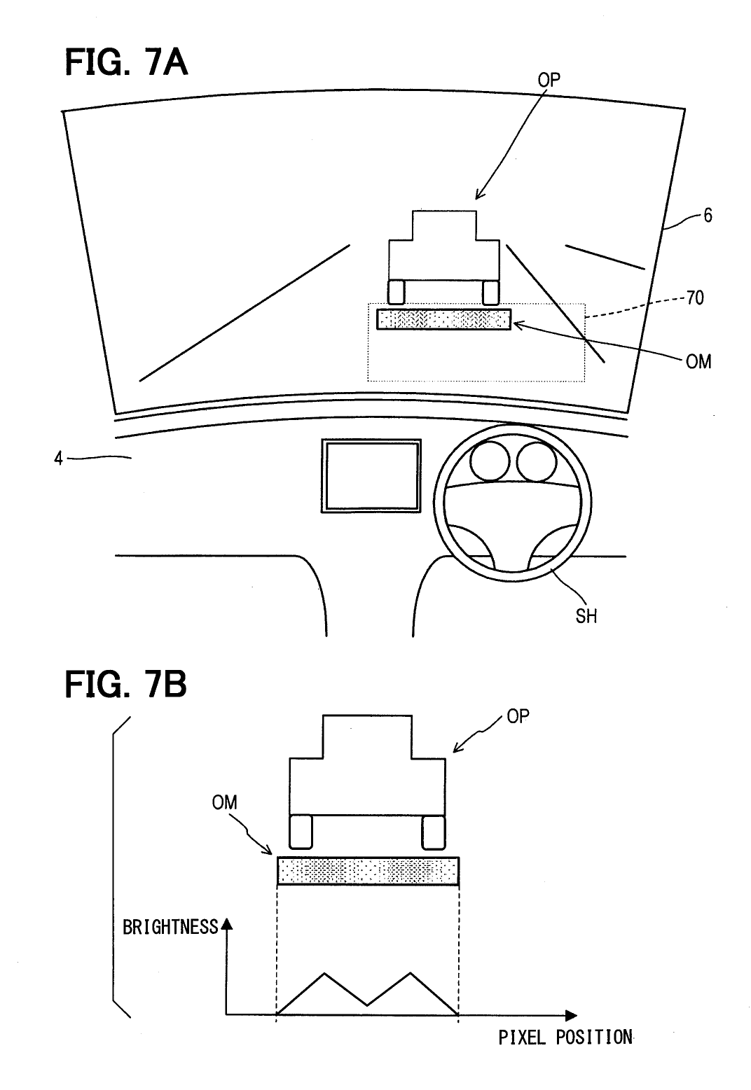

Consequently, when the driver is focused on the object OP existing at a distance from the position where the virtual image VI is formed and the object marker OM is viewed as double vision images due to binocular parallax, the driver recognizes the object marker OM having a continuous shape in which end portions of both double vision images overlap along the width direction of the vehicle as indicated in FIGS. 7A and 7B.

In other words, when the driver is focused on the object OP existing away from the position where the virtual image VI is formed, the head-up display 10 restricts a case in which the virtual image of the object marker OM is viewed by the driver as double vision images.

Further, the above-described embodiment describes that the object marker OM has the rectangular (elongated) shape, and is longer in the width direction of the vehicle than in the height direction of the vehicle.

Consequently, even when the driver is focused on the object OP and the object marker OM is viewed as double vision images, the head-up display 10 can keep the shape of the recognized object marker OM the same as the shape projected onto the windshield 6 (that is, elongated shape). Further, since the displayed object marker OM has the elongated shape, the head-up display 10 can reduce the display region along the height direction of the vehicle and secure an enlarged field of front vision.

Moreover, the head-up display 10 controls the brightness distribution of the object marker OM to be relatively high at the central portion in the width direction of the vehicle and relatively low at both end portions in the width direction of the vehicle.

When the object marker OM is viewed as double vision images in a situation where the object marker OM has the above-described brightness distribution, the brightness of an overlapped portion of the recognized double vision images of the object marker OM can be increased. Thus, the brightness distribution of the recognized object marker OM can be smoothly changed in the width direction of the vehicle.

Consequently, the head-up display 10 enables the object marker OM is recognized by the driver without giving an uncomfortable feeling to the driver.

The head-up display 10 eliminates the necessity of viewing the virtual image VI using a dominant eye only. This avoids a situation where the dominant eye gets fatigued easily.

### Other Embodiments

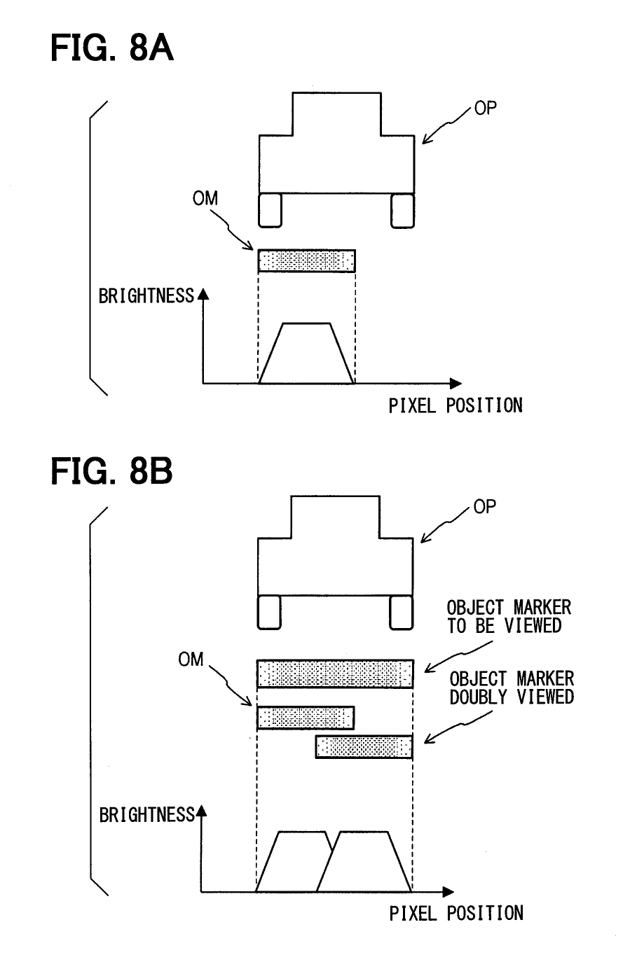

In the foregoing embodiment, the brightness of the object marker OM is distributed such that the brightness is highest at the central portion in the width direction of the vehicle and decreases in proportion to the distance from the central portion in the width direction of the vehicle to a position toward an end portion in the width direction of the vehicle as an example. The brightness distribution of the object marker OM is not limited to this example. As another example, as indicated in FIG. 8A, the brightness of the object marker OM may be distributed such that brightness values of pixels within a predetermined range around the central portion in the width direction of the vehicle have the highest values, and brightness values of pixels decrease in proportion to a distance from an end portion of the predetermined range and a position toward an end portion of the object marker OM.

In the case shown in FIG. 8A, when the object marker OM is recognized as double vision images by the driver, the end portions of both of the double vision images are overlapped to provide an increased brightness as indicated in FIG. 8B. Therefore, the recognized brightness distribution of the recognized object marker OM is smoothly changed at a central portion along the width direction of the vehicle. As a result, the object marker OM is recognized by the driver without giving an uncomfortable feeling to the driver.

Further, the foregoing embodiment assumes that the object marker OM is shaped to be rectangular (elongated) and longer in the width direction of the vehicle than in the height direction of the vehicle. The shape of the object marker OM is not limited to the above. For example, the object marker OM may be in any shape under a condition that the object marker OM has upper and lower sides parallel to the width direction of the vehicle and either the upper side or the lower side, whichever is shorter, is shaped to have at least the display reference length at the position where the virtual image VI of the object marker OM is formed.

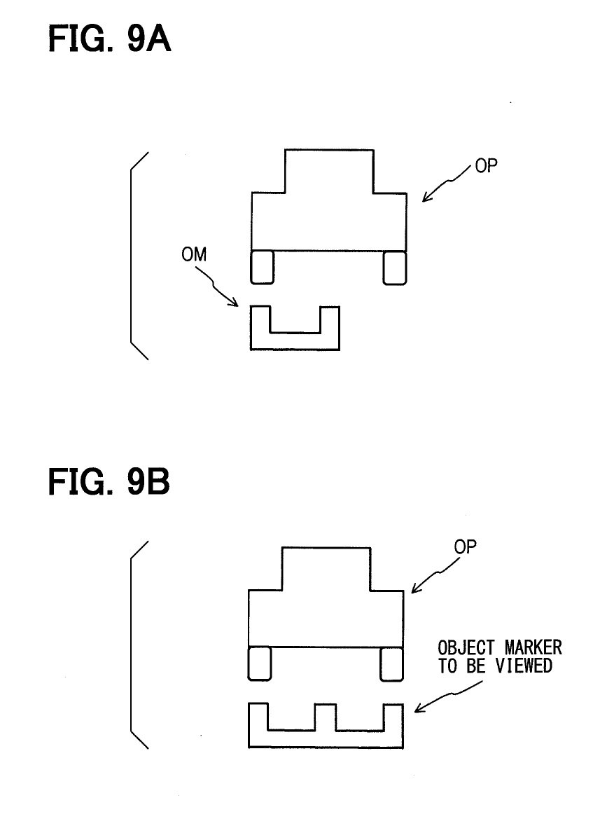

The above-described shape may, for example, have two parallel rectangular portions that are disposed along the height direction of the vehicle, and a rectangular portion that is disposed parallel to the width direction of the vehicle in order to connect the lower ends of the initially mentioned rectangular portions, as indicated in FIG. 9A.

When the object marker OM having the above-described shape is viewed by the driver as double vision images, the object marker OM is recognized as having a shape in which the end portions of both of the double vision images overlap in the width direction of the vehicle as indicated in FIG. 9B as far as the length in the width direction of the vehicle at the position where the virtual image VI of the object marker OM is formed is equal to or longer than the display reference length. Therefore, when the object marker OM has the above-described shape, the driver can recognize the object marker OM as a single continuous marker as shown in FIG. 9B.

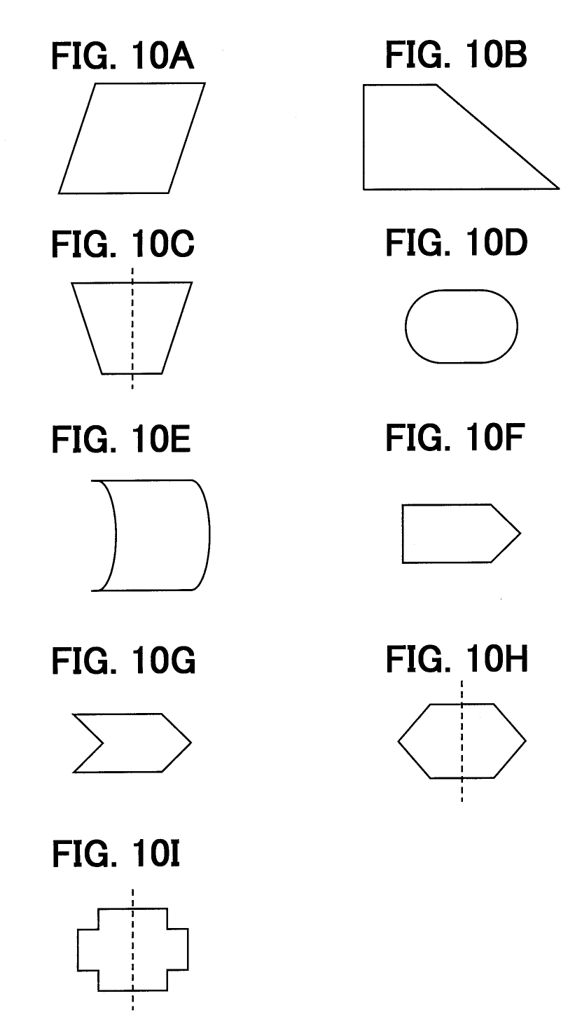

The object marker OM may also be shaped like a parallelogram having two parallel sides along the width direction of the vehicle as depicted in FIG. 10A or like a trapezoid having two parallel sides along the width direction of the vehicle as depicted in FIG. 10B. The trapezoid may be an isosceles trapezoid as depicted in FIG. 10C. Further, the object marker OM may be shaped like a rounded rectangle having two parallel sides along the width direction of the vehicle as depicted in FIG. 10D or like an arrow having two parallel sides along the width direction of the vehicle as depicted in FIG. 10E. The arrow-like shape may be like a pentagon as depicted in FIG. 10F or like a hexagon as depicted in FIG. 10G.

The object marker OM may be shaped like a hexagon having two parallel sides along the width direction of the vehicle as depicted in FIG. 10H or like a cross having two parallel sides along the width direction of the vehicle as depicted in FIG. 10I.

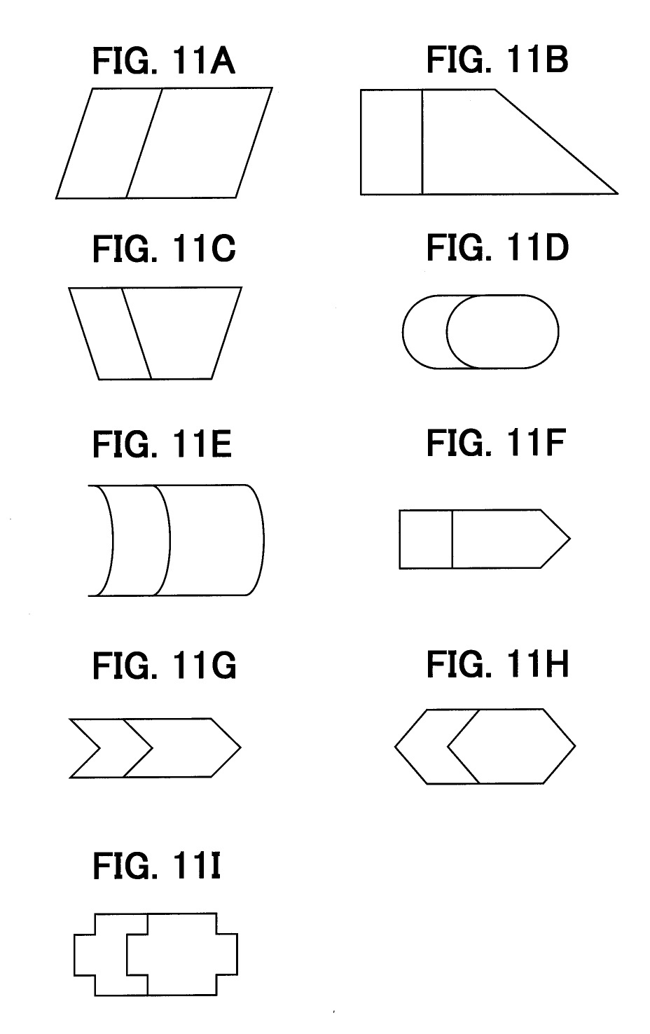

Even if the object marker OM shaped as depicted in FIGS. 10A to 10I is recognized as a double image by the driver, the object marker OM is recognized as having a shape in which the end portions of both of the double vision image overlap in the width direction of the vehicle. In addition, when the object marker OM is shaped as depicted in FIGS. 10A to 10I, the shape recognized by the driver can be as depicted in FIGS. 11A to 11I. As a result, the shape recognized by the driver is similar to the shape of the virtual image VI projected onto the windshield 6.

The present disclosure includes the following aspects.

According to an aspect of the present disclosure, the head-up display 10, which is equipped to a vehicle, includes a front view information acquisition unit, a virtual image display unit, and a size adjustment unit. In the present disclosure, the control apparatus 22 functions as the front view information acquisition unit, the virtual image display unit, and the size adjustment unit. More specifically, the process performed in S110 and S120 by the control apparatus 22 functions as the front view information acquisition unit, the process performed in S180 by the control apparatus 22 functions as the virtual image display unit, and the process performed in S140 to S160 by the control apparatus 22 functions as the size adjustment unit.

The front view information acquisition unit acquires information (this information is hereinafter referred to as “front view information”) indicative of an object existing on a road along which the vehicle travels. The virtual image display unit controls lights for displaying an object marker representing the object indicated by the front view information acquired by the front view information acquisition unit, to be reflected on a windshield so as to display the object marker as a virtual image in front of the vehicle.

When the position where the object indicated by the front view information acquired by the front view information acquisition unit exists is ahead of the position where the object marker is virtually imaged in the traveling direction of the vehicle, the size adjustment unit adjusts the size of the object marker to be displayed by the virtual image display unit in such a manner that the length of the object marker in the width direction of the vehicle at the position where the virtual image is formed is at least equal to or longer than a length (this length is also referred to as “display reference length”)of a line segment that connects, along the width direction of the vehicle and passing through the position where the virtual image is formed, a straight line connecting the right eye of the driver with the object and another straight line connecting the left eye of the driver with the object.

In other words, the head-up display 10 according to the present disclosure displays the object marker so that the length of the object marker in the width direction of the vehicle at the position where the virtual image of the object marker is formed is equal to or longer than the display reference length.

Consequently, when the driver is focused on the object existing away from the position where the virtual image is formed and the object marker OM is viewed as double vision images by the driver due to binocular parallax, the driver recognizes the object marker as having a shape in which the end portions of both of the double vision images overlap with each other. More specifically, according to the head-up display 10 in the present disclosure, the driver recognizes the object marker as a single continuous object displayed along the width direction of the vehicle.

In other words, when the driver is focused on the object existing away from the position where the virtual image is formed, the head-up display 10 according to the present disclosure restricts a case in which the virtual image of the object marker is viewed by the driver as double vision images.

In contrast to the technology described in Patent Literature 1, the head-up display 10 according to the present disclosure saves the driver from viewing the virtual image by using the dominant eye only. This avoids a situation where the dominant eye of the driver gets fatigued easily.

The virtual image display unit in the present disclosure may use the object marker having upper and lower sides that are parallel to the width direction of the vehicle, and either the upper side or the lower side, whichever is shorter, has at least the display reference length.

When the driver is focused on the object and the object marker is viewed by the driver as double vision images, the object marker having the above-described shape enables the driver to directly recognize the shape projected onto the windshield as the shape of the object marker.

The present disclosure may also be implemented as a program that is to be executed by a computer incorporated in the head-up display 10. The present disclosure may be further implemented by various aspects such as a storage medium in which the program is stored, a display control method for the head-up display 10, and a head-up display program product.

When, for example, the present disclosure is implemented as a program, the program may be stored in a DVD-ROM, a CD-ROM, a hard disk, or other computer-readable storage medium and loaded as needed into a computer and started or may be acquired by the computer as needed through a communications link and started for use. Subsequently, the computer is able to function as the head-up display 10 when the computer is allowed to perform various procedures.

While the disclosure has been described with reference to preferred embodiments thereof, it is to be understood that the disclosure is not limited to the preferred embodiments and constructions. The disclosure is intended to cover various modification and equivalent arrangements. In addition, while the various combinations and configurations, which are preferred, other combinations and configurations, including more, less or only a single element, are also within the spirit and scope of the disclosure.

1. A head-up display equipped to a vehicle comprising:
a front view information acquisition unit acquiring front view information indicative of an object existing on a road along which the vehicle travels;
a virtual image display unit controlling lights, which are generated for displaying an object marker corresponding to the object indicated by the front view information acquired by the front view information acquisition unit, to be reflected on a windshield of the vehicle and displaying the object marker representing the object as a virtual image in front of the vehicle; and
a size adjustment unit adjusting a size of the object marker displayed by the virtual image display unit when a position where the object exists is ahead of a position where the virtual image of the object marker is formed in a traveling direction of the vehicle, wherein the size adjustment unit adjusts the size of the object marker so that a length of the object marker in a width direction of the vehicle is at least equal to or longer than a display reference length, and the display reference length is defined as a length of a line segment that connects, along the width direction of the vehicle and passing through the position where the virtual image of the object marker is formed, a straight line connecting a right eye of a driver of the vehicle with the object and another straight line connecting a left eye of the driver with the object.

2. The head-up display according to claim 1, wherein
the virtual image display unit defines a shape of the object marker so that an upper side and a lower side of the shape of the object marker are parallel to the width direction of the vehicle and a shorter one between the upper side and the lower side of the shape of the object marker has a length equal to or longer than the length of the display reference length.

3. The head-up display according to claim 2, wherein
the object marker displayed by the virtual image display unit has an elongated shape which is longer in the width direction of the vehicle than in a height direction of the vehicle.

4. The head-up display according to claim 1, further comprising:
a brightness adjustment unit adjusting a brightness of the object marker displayed by the virtual image display unit so that the brightness at a central portion of the object marker in the width direction of the vehicle is higher than the brightness at both end portions of the object marker in the width direction of the vehicle.

5. A computer-readable head-up display program product comprising instructions to be executed by a computer included in a head-up display equipped to a vehicle, the instructions for implementing:
acquiring front view information indicative of an object existing on a road along which the vehicle travels;
controlling lights, which are generated for displaying an object marker corresponding to the object indicated by the front view information acquired in an acquiring step of the front view information, to be reflected on a windshield of the vehicle and displaying the object marker representing the object as a virtual image in front of the vehicle; and
adjusting a size of the object marker displayed in a displaying step of the object marker when a position where the object exists is ahead of a position where the virtual image of the object marker is formed in a traveling direction of the vehicle, wherein the size of the object marker is adjusted so that a length of the object marker in a width direction of the vehicle is at least equal to or longer than a length of a line segment that connects, along the width direction of the vehicle and passing through the position where the virtual image of the object marker is formed, a straight line connecting a right eye of a driver of the vehicle with the object and another straight line connecting a left eye of the driver with the object.
